(19) United States
(12) Patent Application Publication
(10) Pub. No.: US 2013/0023335 A1
(43) Pub. Date: Jan. 24, 2013

(54) Four Card Poker Game with Variable Wager

(71) Applicant: Roger M. Snow, Las Vegas, NV (US)

(72) Inventor: Roger M. Snow, Las Vegas, NV (US)

(21) Appl. No.: 13/631,818

(22) Filed: Sep. 28, 2012

Related U.S. Application Data
(63) Continuation-in-part of application No. 11/499,864, filed on Aug. 4, 2006.
Application No. 11/499,864 is a continuation of application No. 10/152,325, filed on May 20, 2002, now abandoned.

(51) Int. Cl. A63F 13/00

(52) U.S. Cl. 463/22

(57) ABSTRACT

A casino game utilizes at least one deck of playing cards, the game comprising: each player placing at least one wager to participate in the casino game; dealing a first number of cards to a dealer, the first number of cards being greater than the number of cards to be used in determination of a poker rank hand for the dealer; dealing a second number of cards to each player, the second number of cards being greater than the number of cards to be used in determination of a poker rank hand for each player; the dealer discarding at least one card to form a resulting single dealer hand; each player discarding at least one card to form a resulting player's hand for each player, wherein the number of cards in resulting player's hands and the resulting dealer's hand are equal; and resolving each player hand against the dealer's hand according to predetermined game rules. The initial player's wagers must be at least matched with a Game Bet (or play bet) to remain in the game after players have received their cards. The Game Bet may be multiples of the initial player's wagers, for example, 1× to 5× the initial wager, or more.

### CROSS REFERENCE TO RELATED APPLICATION

This application is a continuation-in-part of U.S. patent application Ser. No. 11/499,864, filed Aug. 4, 2006, which is a continuation of U.S. patent application Ser. No. 10/152,325 filed May 20, 2002, the disclosure of each of which is incorporated herein by reference.

### 1. FIELD

The present invention relates to the field of games, card games, wagering card games and especially poker-type casino wagering games.

### 2. BACKGROUND

The present invention generally relates to a card game that can be played in a casino or in a card room. More particularly, it relates to a modified version of a stud poker game.

Many different wagering games presently exist for use in both home and casino environments. Such games should necessarily be exciting, uncomplicated and easy to learn so as to avoid frustrating the players. Designing new games that meet these criteria and are sufficiently different from old games to entice players to play the new game is a particularly challenge.

### SUMMARY

A casino table poker game is played with poker hands of players competing against a poker hand of a dealer. A player enters the game by placing one or both of a Bonus Bet (also referred to as an Aces-Up wager) for competition against a pay table and an Ante for direct competition against the dealer. The player is dealt more cards than needed to form a poker hand. The dealer is also provided with more than the required number of cards, from which a number of cards are selected for the dealer's hand to play. The player is provided with bonus payouts (e.g., multiple returns) on the Aces-Up bet for ranked hands or a pair of Aces or better. The players' hands also compete directly against the rank of the dealer's hand if an additional play bet is placed to supplement the ante. The additional play bet may be varied by the player to be 1×, 2×, 3×, 4×, or 5× the amount of the ante. Bonuses may also be paid on the Aces-Up or ante wager with unusually high ranking player's hands (such as a straight flush or four of a kind), whether or not the rank of the player's hand exceeds the rank of the dealer's hand.

### BRIEF DESCRIPTION OF THE FIGURES

FIG. 1 is a plan view of a gaming table layout suitable for play of the game of according to an embodiment.

FIG. 2 is a schematic block diagram of a gaming system for implementing wagering games according to an embodiment.

FIG. 3 illustrates a block diagram of a gaming system that offers wagering games according to one embodiment.

FIG. 4 is a block diagram of a gaming system providing for live dealer play for a user at a remote user device according to one embodiment.

FIG. 5 is a high-level block diagram of a computer for acting as a gaming system according to one embodiment.

### DETAILED DESCRIPTION

The terms “gaming,” “gambling,” or the like, refer to activities, games, sessions, rounds, hands, rolls, operations, and other events related to wagering games such as web games, casino games, card games, dice games, and other games of chance for which wagers may be placed by a player. In addition, the word “wager,” “bet,” “bid” or the like, refer to any type of wagers, bets or gaming ventures that are placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games using real currency, virtual credits, or other countable elements.

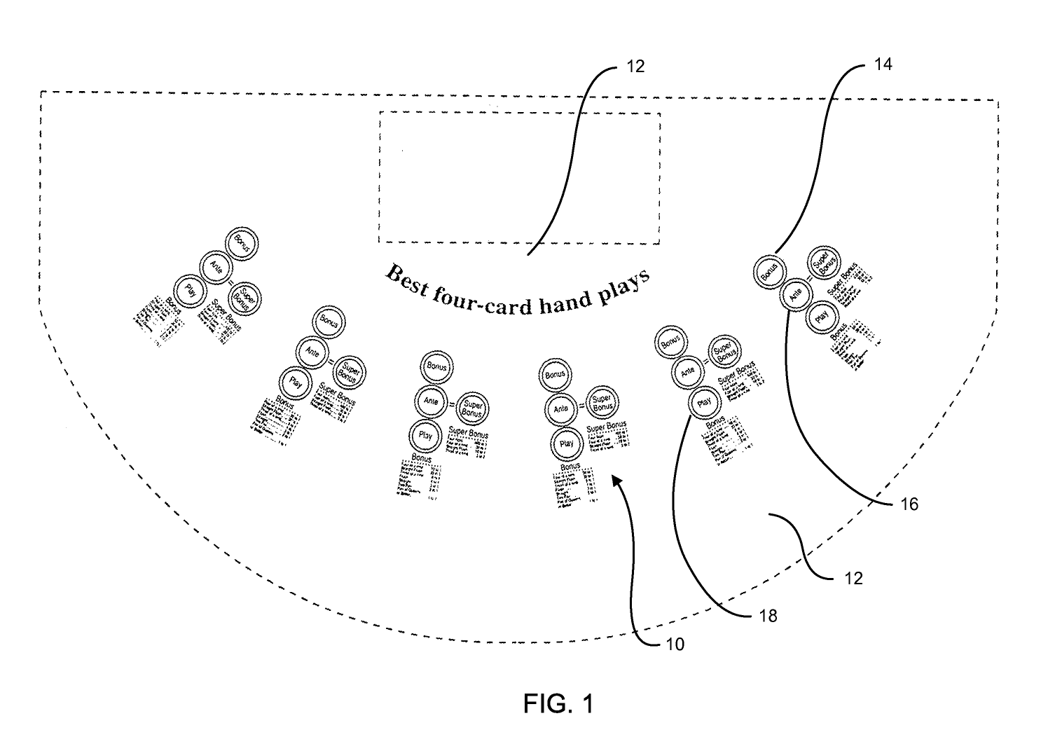

A casino table card game is played on a table by at least one player and a dealer. The dealer usually represents the house or the casino in the play of the game. As shown in FIG. 1, wagering areas 10 are provided for each player, and card receiving areas 12 are available for each of the players and the dealer. The wagering area may include three distinct wagering zones for each player comprising a Bonus wager area 14 (e.g., an Aces-Up wager), an Ante area 16, and a Bet area 18. To initiate play of the game, at least one (and usually only one) deck of standard or variant playing cards is provided. In other forms of the game, multiple intermixed decks of cards, decks with wild cards or special decks (i.e. decks with certain cards removed) are used. Each player who wishes to enter the play of the game makes at least one wager selected from the Bonus Bet (or Aces-Up bet) and the Ante. One or both of these wagers may be made. The player may also play the hand blind (also referred to as the “House Way”) by placing both an Ante and an additional Game Bet (referred to in FIG. 1 as the “Play Bet”). After placement of the at least one wager, each player who has made an at least one wager is provided with five cards, in this embodiment, from which to select a best four-card poker hand. The cards may be dealt as a complete set of five cards or in portions of one or more cards. At about the same time, the dealer is dealt a number of cards exceeding four. In one embodiment, six cards are dealt to the dealer. One or more additional cards can be dealt to the player, the dealer or both.

Although in one example the dealer receives one more card than each player, the number of cards dealt can be equal. In particular, enough cards are dealt so that at least one discard can be made.

In an embodiment, a four card poker hand is played. The player reviews the five cards received at that player position and determines what best four-card poker hand can be made from the five cards. If the player believes that the cards cannot form a four-card poker rank of sufficiently high rank to warrant competition against the dealer's hand (even without that hand or any portion of that hand having been displayed), the player may fold the hand, refusing to place an additional wager. At this time or usually a later time, the Ante would be collected by the dealer. In one example, if the player made the Aces-Up bet and the Ante bet and decides to fold, the Aces-Up bet is swept along with the Ante. In another embodiment, if the player remains in the game by making the Play Bet and the player's hand does not contain a hand ranking of a pair of Aces or higher, and a bet was made on the Ace-Up wager, that wager may be now or later collected by the dealer. If the player determines that the rank of the best four-card poker hand that can be made from the five cards dealt to the player is sufficiently high as to warrant competition against the dealer (or if the player wants to ‘bluff’ against the dealer, particularly if the dealer must qualify), the player makes an additional wager, referred to as a play bet or game bet. That additional wager may be multiples of the Ante, such as DC, 2×, 3×, 4× or 5× the amount of the original Ante, at the option of the player. In some embodiments, the game bet is DC the ante unless the player has a qualifying hand such as a pair of kings or better for example. If the player's hand qualifies he has the option of increasing his bet. Fractional amounts or larger amounts may be allowed, but they can complicate the payout or alter the hold for the house, so those changes are in the discretion of the casino. After discarding excess cards and placing the Game Bet, or placing the fifth card face down, or merely leaving the fifth card in the hand so that the hand may be arranged and ranked by the dealer or player when exposed, the player's hand is placed on the table for display. The dealer's hand is then revealed after each and every player has determined whether or not the Game Bet is to be made. The dealer compares the value or rank of his hand against the value or rank of each player's hand, usually in succession around the table, and each series of wagers (the Aces-Up wager, the Ante and the Game Bet) is resolved. Ties on the rank of player's hands and dealers hands may be either paid to the player, called a push, or collected by the dealer, depending upon the desired house advantage the casino wants to build into the game. The dealer may either always qualify to play, or a level of qualification may be built into the game (such as at least Queen high, at least King high, at least Queen-Jack, At least King-Jack, at least Ace-King, or at least one pair).

Resolution on the wagers may be based upon pay tables for the Aces-Up wager, pay tables on the Ante, and/or the Game Bet. One embodiment of play of the game provides pay tables for one or more of the Aces-Up wager, the Ante and an automatic bonus payout on the ante. The Game Bet pays one-to-one with a player win. Because the player can see the strength of the player hand when making the game bet, the player would be at an extreme advantage in placing a 5× Game Bet, assuring a very high multiple payout, with essentially no risk or little risk involved in the placement of the 5× Game Bet wager. The payout of wagers may be tailored by the casino by selecting pay tables designed for greater player payouts or greater casino earnings.

Although a four card poker game is one embodiment, the game could also be played with three, five or seven cards, with necessary adjustments to the pay tables.

For example, in a four card game, the hierarchy of hands is as follows:
Four of a Kind
Straight Flush
Three of a Kind
Flush
Straight
Two Pair
Pair
High Card.

A three or five card game may require a different hierarchy of hand rankings

There are many variations of the game that may be played. The following variations on the format described above illustrate the expanded scope of play available under various methods.

Version I—Each player receives 5 cards, and the dealer receives 6 cards. The players and the dealer identify their best four card poker hands, the players may rely upon the house for assistance, if needed. The dealer always qualifies, that is the dealer's hand and any players' hands are always in play if the ante bet is made. Players have the choice of placing one or both of the Ante Bet and a Bonus Bet (e.g., the Aces-Up wager). House rules may require the player to make the Ante Bet, the Bonus Bet, or both the Ante and Bonus Bet. The Ante wager is a wager directly against the rank of the dealer's hand, and the Aces Up Bonus Bet is a bet against a pay table. If after viewing his/her hand, a player chooses to stay in the game against the dealer (keeping the Ante wager in play), the player must make an additional Game Bet to stay in the game. This Game Bet may be, for example, between 1 and 5 (or between 1 and 4, or between 1 and 3) times the amount of the initial Ante wager at the opinion of the player. In other forms of the game, the player's Game Bet must be 1× the ante unless the player holds a qualifying hand of a pair of Aces or better. If the player has a qualifying hand, he can bet up to 3× the Ante. The player must hold a pair of aces or better to win on the Bonus Bet (hence the name ‘Aces-Up’) in this embodiment. The Bonus Bet pays a maximum return of 50:1 in one embodiment, but payouts may theoretically be as high as 500:1 for certain hands, such as for four Aces. The Bonus Bet side bet game may or may not be present in the rules of the game. In this example, the game pays an automatic bonus for certain high ranking hands according to a payout schedule. This bonus is paid on the Ante wager, and does not require the player to make a separate bet to qualify for this payout. For example, automatic bonuses are paid on three of a kind, straight flushes and four of a kind.

Version II—Each player and the dealer gets five cards to make the best four-card poker hand. If the dealer's hand does not equal or exceed a certain rank (e.g., a pair of 2's or better), he discards all cards and draws a new five card hand, and then makes a four-card poker hand from the five cards. The player must make the Ante wager to be in the game against the dealer. The dealer always qualifies to play against the player. It is possible to allow the player or require the player to make the Ante wager 1) before the deal of cards, 2) after the deal of cards but before any cards are revealed, 3) after the deal of cards and after the players has reviewed his cards but before the dealer has exposed cards, 4) after the deal of cards and a partial or complete revelation of the dealer's five cards (but before review of the player's cards), or 5) after the deal of cards and a review of the players' cards and a partial revelation or complete revelation of the dealer's five cards, which play might be restricted to where the dealer has not qualified (but not after revelation of any sixth card). The player's hand may be required to exceed a minimum rank to bet more than 1× the Ante. For example, if the player has a qualifying hand of a pair of Kings or better, the player can make a Game Bet of 1×, 2× or 3× the Ante. As with Version I, the rules can provide that the Bonus Bet (side bet) is mandatory or both initial bets (the Ante and the Bonus Bet) are mandatory. The automatic bonus against a pay table on the Ante bet may or may not be present in the rules of the game. The Bonus Bet game may or may not be present, also in the rules of the game. In this example, a pair of aces or better qualifies the player for an Aces-Up payout of 1:1. The automatic bonus pays even if the player's hand is lower in rank than the dealer's hand.

Version III—The players and dealer each receive five cards to make their best four-card poker hand. The betting/wagering rules and procedures are the same as in the previous versions, except for those listed below. Either the Ante is mandatory, the Ante or the Bonus Bet is mandatory, or both initial wagers are mandatory. The dealer must qualify to play (for example, with a hand of Ace high or better, King-Queen or higher, Ace-King or higher, pair of deuces or higher, etc.). The automatic bonus side bet game against a pay table is present in the rules of this example of the game.

If the player stays in the game, the player can bet 1× to 3× the Ante if the player has a qualifying hand of a pair of Kings or better. Otherwise, the maximum Game Bet is 1× the Ante. The lowest ranking hand that qualifies for the bonus payout is a pair of Aces or better.

Version IV—Four Card Poker with Super Bonus—The dealer and each player are dealt five cards each. The cards are used to make the best four card poker hand by the players and the dealer. The hands are ranked according to the following four card poker ranking schedule:
Four of a Kind
Straight Flush
Three of a Kind
Flush
Straight
Two Pair
Pair
High Card.

Players can make a bet against the dealer (Ante), a bet against the pay table (Aces-Up Bonus Bet) or both. House rules may require one or both bets to be mandatory. In addition, the players are required to make a Super Bonus bet in an amount equal to the Ante in this version.

Players place equal bets on the Ante and/or Super Bonus and/or Bonus spots on the layout. After viewing the cards, the player must fold or place an additional Bet (play wager). If the player's hand does not qualify with a pair of Kings or better, he must bet 1× the ante to stay in the game. With a qualifying hand of a pair of Kings or better, he can bet an amount equal to or multiples of the Ante, such as 1×, 2× or 3× the Ante.

If the player has a higher ranking hand than the dealer's hand, the player is paid 1:1 on the ante and the play bet. If the dealer's hand outranks the player's hand, the player loses the ante and the play bet.

The player has the option (or may be required) at the beginning of the game to place an Aces-Up bonus bet. In this example, the player wins a bonus payout for a pair of Aces or better. If the player makes the Ante and Play bets and beats the dealer, but does not have a pair of Aces or better, the player pushes on the bonus bet. The player is always paid on the Aces-Up bonus bet, regardless of whether or not the player's hand beats the dealer's hand.

In addition, this example includes a mandatory Super Bonus bet that is made in an amount equal to the ante. The player wins a payout for certain high ranking hands such as a straight flush or four of a kind A pay table is provided on the layout to identify winning hands and payout amounts.

A failure to obtain a “Super Bonus” hand does not result in an automatic loss of the bet.

For example, when the player's hand against the dealer does not qualify with a pair of kings or a straight flush or better, but the hand still beats the dealer, the Super Bonus bet pushes. But, if the player folds on the ante or lose the ante and play bets against the dealer, the Super Bonus bet is also lost.

The Super Bonus bet is desirable in some instances where it is desired to provide the house with more of an advantage. In this example of the game, removing the mandatory Super Bonus bet causes the game to favor the player. However, other rule changes such as requiring the dealer to qualify, or raising the minimum qualification hand ranking when making the play bet are other means to shift the odds to favor the house.

There are a number of advantages of the games as described herein. The fold rate for a player using good strategy on this game is approximately 21%, which is lower than the fold rate in some other games. This feature is believed to attract and retain players, making the game more appealing to casinos.

Players win this game approximately 48% of the time, which exceeds the expectation of many players, and increases player appeal.

In some situations, e.g., when the player has a qualifying hand, additional betting opportunities are available, such as tripling down on the Ante, increasing player appeal.

By varying the number of cards made available to the dealer and/or players, in forming the hands, by requiring the dealer's hand to qualify or by eliminating dealer qualification, by modifying the payouts and winning hand combinations possible on the bonus bet, by adding the Super Bonus bet etc., the payouts can be made to pay as high as 500:1, e.g., for four of a kind hands. This feature is believed to attract and retain more poker players.

The play of the game may be completed manually on a non-electronic game table, with the dealer using a physical deck(s) of cards, visually identifying the amounts and positions of wagers, manually collecting and paying out wagers, etc. It is possible to incorporate some degree or nearly an entire electronic system into the game table or into the play of the game. Such partial or complete electronic systems may perform such tasks as identifying the existence of a wager (e.g., U.S. Pat. Nos. 6,229,534; 5,337,973; and 5,377,994), or may provide virtual cards from an electronically stored deck of cards (e.g., U.S. Pat. Nos. 5,255,915; and 5,897,436). The entire disclosure of each of these patents is hereby incorporated by reference. The capabilities of technology are constantly expanding, and the improvements in technology should not be considered to avoid the underlying invention of the play of this game. For example, player monitoring systems, security systems, integrated systems where shufflers identify the number of cards and/or identify the specific cards and their positions in the play of the game are contemplated in the practice of the present invention.

For the purposes of this disclosure, it will be understood that when a game and any actions associated with the game are described, that game and its rules and actions are also useable in an electronic version of the game (an electronic or on-line version of the game or games using the same set of rules and/or game play).

Gaming actions and rules such as accepting wagers, making payouts, dealing cards, selecting cards, and other actions associated with a player or a dealer include physical and electronic embodiments. Thus, when a description is given of a player or dealer taking a game related action, it is intended that the embodiments include action on a live gaming table, a virtual table or display, and the generation, transmission, and reception of such an action in an electronic form where player and dealer choices, selections, or other actions are received at an electronic interface. This further includes the results of a virtual dealer and virtual players, where the actions described are actually generated by a computer (typically associated with an on-line game). As an example, if dealing of a card is described herein, the description includes providing a card to be associated (associable) with the applicable position in the game, such as a player, dealer, or a community. Such dealing includes (but is not limited to): the dealing of a card by a dealer from a deck, shuffler, or other card source and the reception or placement of the card at a table location associable with a player, or reception directly by a player; or, the generation and transmission of an electronic indication of a card from a game play source or server to an electronic receiver, where the receiver may be at a table (virtual cards) including players and/or virtual players and/or a dealer or virtual dealer, at a public display in a casino, at a remote location (on-line or internet game play), or other locations, and also including the representation of a card on a display or displays, and, if applicable to the action described, an electronic reception of an indication that the card has been received, selected, or otherwise interacted with at a location associable with a player, or, associated with a virtual player.

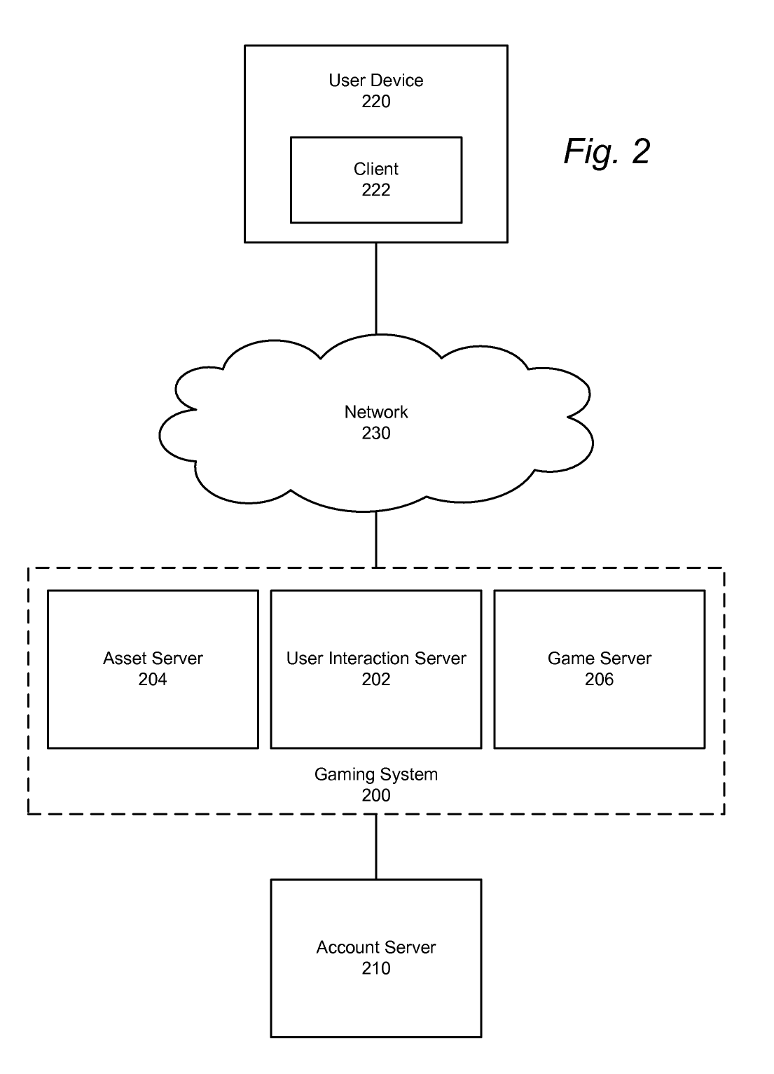

FIG. 2 is a schematic block diagram of a gaming system 200 for implementing wagering games according to an embodiment. The gaming system 200 enables end users to access wagering game content. Such game content may include, without limitation, various types of wagering games such as card games, dice games, big wheel games, roulette, scratch off games, and any other wagering game with a randomized element in determining wagering outcomes. Such games in may be played against the gaming system or against other end users. In particular, the gaming system 200 allows users to play variants of the wagering games described above.

The wagering games supported by the gaming system 200 may be operated with real currency or with virtual credits. For example, the real currency option may include traditional casino and lottery-type wagering games in which money or other items of value are wagered and may be cashed out at the end of a game session. The virtual credits option may include wagering games in which credits (or other symbols) may be issued to a player to be used for the wagers. For example, credits may be purchased by a player or issued through other methods. Although credits may be won or lost, the ability of the player to cash out the credits may be prevented. In other words, while the credits may be purchased, the credits in a play for fun option may be limited to non-monetary credits in terms of the ability of the player to extract cash or goods or services of monetary value out of the wagering game. Systems that operate play for fun games may include issuance of free credits. In some embodiments, a limited number free credits may be issued in order to entice players to play the games. Credits may be won or lost, but credit balances may not be cashed out. In exchange for identifying friends who may want to play, the system may issue additional credits. Often, additional credits may be issued after a period of time has elapsed to encourage the player to resume playing the game. The system may enable players to buy funds or additional game credits to allow the player to resume play. Objects of value may be awarded to play for fun players, which may or may not be in a direct exchange for credits. For example, the client may award a prize for a highest scoring play for fun player during a defined time interval.

The gaming system 200 includes a gaming platform that establishes a portal for an end user to access a wagering game hosted by a game server 206 through a user interaction server 202. The user device 220 communicates with a user interaction server 202 of the gaming system 200 using a network 230. The user interaction server 202 communicates with the game server 206 and provides game information to the user. In some embodiments, a single user device communicates with a game provided by the game server 206, while other embodiments may include a plurality of user devices 220 configured to communicate and provide end users with access to the same game provided by game server 206. In addition, a plurality of end users may access a single user interaction server 202 or a plurality of user interaction servers 202 to access game server 206.

The user interaction server 202 communicates with the user device 220 to enable access to the gaming system 200. The user interaction server 202 allows a user to create and access a user account and interact with gaming server 206. The user interaction server 202 allows users to initiate new games, join existing games, and interface with games being played by the user.

The user interaction server 202 may also provide a client 222 for execution on the user device for accessing the gaming system 200. The client 222 provided by the gaming system 200 for execution on the user device 220 can comprise a variety of implementations according to the user device and method of communication with the gaming system 200. In one embodiment, the user device 220 connects to the gaming system 200 using a web browser and the client 222 executes within a browser window or frame of the web browser. In another embodiment, the client 222 is a stand-alone executable on the user device 220.

For example, the client 222 may comprise a relatively small amount of script (e.g., JavaScript), also referred to as a “script driver,” including scripting language that controls an interface of the client 222. The script driver may include simple function calls requesting information from the gaming system 200. In other words, the script driver stored in the client 222 may merely include calls to functions that are externally defined by, and executed by, the gaming system 200. As a result, the client 222 may be characterized as a “thin client.” As that term is used herein, the client 222 may be little more than a script player. The client 222 may simply send requests to the gaming system 200 rather than performing logic itself. The client 222 receives player inputs and the player inputs are passed to gaming system 200 for processing and executing the wagering game. In other embodiments, the client 222 comprises an executable rather than a script. As a result, the bulk of the processing of the game play is performed in the gaming system 200. The client 222 may receive intermediate data and final game outcome information from the gaming system 200 for displaying on the end user's computer after such is determined by the game server 206.

In another embodiment, the client 222 implements further logic and game control methodology beyond the thin client described above. For example, the client 222 may parse and define player interactions prior to passing the player interactions to the gaming system 200. Likewise, when the client 222 receives a gaming interaction from the gaming system 200, the client 222 may be configured to determine how to modify the display as a result of the gaming interaction. The client 222 may also allow the player to change a perspective or otherwise interact with elements of the display which do not change aspects of the game.

The gaming system 200 also includes an asset server 204 which hosts various media assets (e.g., audio, video, and image files) that may be sent to the client 222 for presenting the various wagering games to the end user. In other words, in this embodiment the assets presented to the end user are stored separately from the client 222, and the client 222 requests the assets appropriate for the game played by the user. For example, the client 222 may call a function defined at the user interaction server 202 or asset server 204 which determines what assets are to be delivered to the client 222 as well as how the assets are to be presented by the client 222 to the end user. Different assets may correspond to the various clients that may have access to the game server 206 or to different games to be played.

The game server 206 is configured to perform game play methods and determine game play outcomes that are provided to the user interaction server 202 to be transmitted to user device 220 for display on the end user's computer. For example, the game server 206 may include game rules for one or more wagering games, such that the game 206 controls the game flow for a selected wagering game, as well as the determining game outcomes, pay tables, and other game logic. The game server 206 also performs random number generation for determining random game elements of the wagering game. The game server 206 is typically separated from the user interaction server 202 by a firewall or other method of preventing unauthorized access to the game server 206 from the general members of the network 230.

The user device 220 presents a gaming interface to the player and communicates the user interaction to the gaming system 200. The user device 220 may be any electronic system capable of displaying gaming information, receiving user input and communicating the user input to the gaming system 200. As such, the user device 220 can be a desktop computer, a laptop, tablet computer, set-top box, mobile device, kiosk, terminal, or other computing device. The user device 220 operates the client 222 for connecting to the interactive gaming system 200 as described above. The client 222 may be a specialized application or may be executed within a generalized application capable of interpreting instructions from the interactive gaming system 200, such as a web browser.

The client 222 may interface with an end user through a web page, an application (e.g., a smartphone or tablet application), or other computer program in order to access the gaming system 200. The client 222 may be illustrated within a casino webpage (or other interface) indicating that the client 222 is embedded into a webpage, which is supported by a web browser executing on the client device 220.

The gaming system 200 may be operated by different entities in one embodiment. The user device 220 may be operated by a third party, such as a casino, that links to the gaming system 200. Therefore, in some embodiments, the user device 220 and client 222 is operated by a different administrator than the operator of the game server 206. In other words, the user device 220 may be part of a third-party system that does not administer the game server 206. In another embodiment, the user interaction server 202 and asset server 204 are provided by a third-party system. For example, a gaming entity (e.g., a casino) may operate the user interaction server 202 or user device 220 to provide its customers access to game content managed by a different entity. In some embodiments, these functions are operated by the same administrator. For example, a gaming entity (e.g., a casino) may elect to perform each of these functions in-house, such as providing both the access to the user device 220 and the actual game content and providing administration of the gaming system 200.

The gaming system 200 also communicates with external account servers 210, optionally through another firewall. For example, the gaming system itself may not take wagers or issue payouts. In other words, the gaming system 200 may facilitate online casino gaming, but may not be part of a self-contained online casino itself. Instead, the gaming system 200 may facilitate the play of proprietary card game content owned and controlled by a company offering games and gaming products and services, such as Shuffle Master, Inc. Another entity (e.g., a casino) may operate and maintain its external account servers 210 to take bets and make payout distributions. The gaming system 200 may communicate with the account servers 210 to verify the existence of funds for wagering, and instructs the account servers 210 to execute debits and credits.

In some embodiments, the gaming system 200 may take bets and make payout distributions, such as in the case where administrator of the gaming system 200 operates as a casino. As discussed above, the gaming system 200 may be integrated within the operations of a casino rather than separating out functionality (e.g., game content, game play, credits, debits, etc.) among different entities. In addition, for “play for fun” wagering games, the gaming system 200 may issue credits, take bets, manage the balance of the credits according to the game outcomes, but may not permit payout distributions or be linked to play for fun account servers 210 that permit payout distributions. Such credits may be issued for free, through purchase, or for other reasons, without the ability for the player to cash out. Such play for fun wagering games may be played on platforms that do not permit traditional gambling, such as to comply with jurisdictions that do not permit online gambling.

The gaming system 200 may be configured using a distributed server architecture. For example, the game server 206 may be include a plurality of servers (e.g., game rules server, deck server, game routing server, account server, asset server, etc.) that are logically separated to perform different functions for the wagering game. Additional features may be supported by the game server 206, such as hacking and cheating detection, data storage and archival, metrics generation, messages generation, output formatting for different end user devices, as well as other features and operations. For example, the gaming system 200 may include additional features and configurations as described in U.S. patent application Ser. No. 13/609,031, filed Sep. 10, 2012, and entitled “Network Gaming Architecture, Gaming Systems, and Related Methods,” the entire disclosure of which is incorporated herein by this reference.

The network 230 enables communications between the user device 220 and the gaming system 200. A network may also connect gaming system 200 and account server 210 (not shown). In one embodiment, the network 230 uses standard communications technologies and/or protocols. Thus, the network 230 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 230 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 230 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 230 can also include links to other networks such as the Internet.

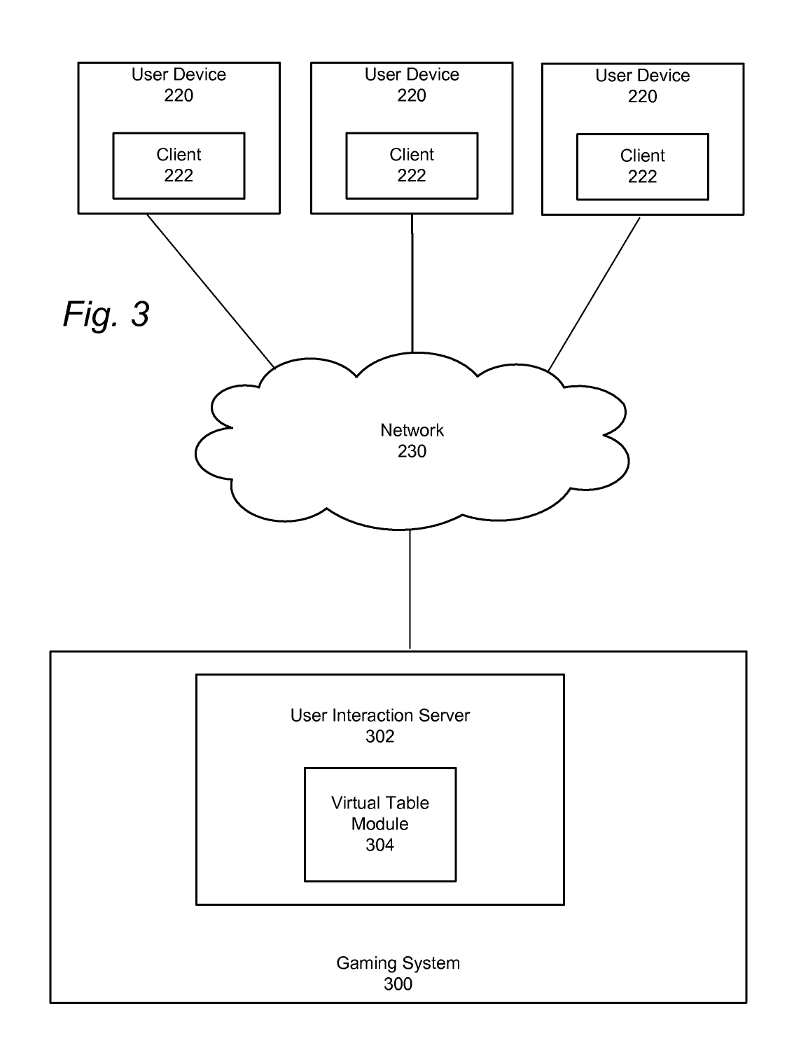

FIG. 3 illustrates a block diagram of a gaming system 300 that offers wagering games according to one embodiment. The gaming system 300 provides gaming services to a plurality of user devices 220 in a similar manner to the gaming system 200 described above with respect to FIG. 2. Accordingly, common components between gaming system 300 and gaming system 200 may include an asset server 204, gaming engine 206, and a communication with an account server 210. The user interaction server 302 provides similar functionality to user devices 220 as provided by user interaction server 202. User interaction server 302 includes additional functionality using a virtual table module 304 for providing a virtual table to the user devices 220.

The virtual table module 304 creates and manages virtual tables for use by the user devices 220. A virtual table is a simulation of a table as may be used on a casino floor. As such, the virtual table allows a specific number of players to join a game hosted by the gaming system 300. The game may be operated by the game server 206. A lobby may be provided to the player of the user device 220, allowing the user to browse various tables that may be joined by the player. Once a player joins a virtual table, the virtual table module 304 provides a virtual table interface to the user device.

The virtual table interface provided by the virtual table module 304 displays appropriate play areas to the user according to the game being played by the user. For example, a user choosing to play a game as described above, and shown with respect to FIG. 1 may be shown play areas for multiple players in the game. To take particular actions relative to the action in the game, the player takes action in gameplay areas associated with the particular player. In addition, when the dealer takes actions, the dealer's actions are relayed to each of the other players. In certain games, a player may take actions in the game simultaneously and in others the player must wait for the game's action to be on the player before the player may act. The virtual table interface provides the user the ability to view virtual actions taken by other players in addition to actions taken by the player himself. Using the virtual table module 304, the gaming system 300 provides a virtual experience to the user similar to play on a casino floor.

In addition to actions taken responsive to the gameplay, players may also view other information provided by the other players. For example, like sitting at a table in person, the players at the virtual table may chat with one another, for example via a chat interface, and optionally communicate with an audio connection if a microphone and speakers are available at the user devices 220. In addition, for games where a player is provided a card or cards face-down, the player may also choose to reveal the player's card(s) to the other players at the table. Thus, the virtual table enables the players to engage in interactions with others players at the table as though the players were actually in person together at a table at the casino floor.

In one embodiment, the virtual table module 304 provides the players with an image of a virtual dealer. The virtual dealer provides interaction with the various players of the game, indicating, for example, when it is a player's turn to take an action. The user interface for each player may be customized for each player's perspective at the virtual table. For example, the player at the first seat at the table is provided a view different from the second seat, the third seat, etc. As such each player may have a different view of the table, as well as a perspective on the virtual dealer. Thus, when the virtual dealer is indicating that the second seat must act in the game, to the player in the second seat the perspective indicates the virtual dealer is gesturing to that player, while a player in the first seat is provided a different perspective of the virtual dealer indicating to the second seat.

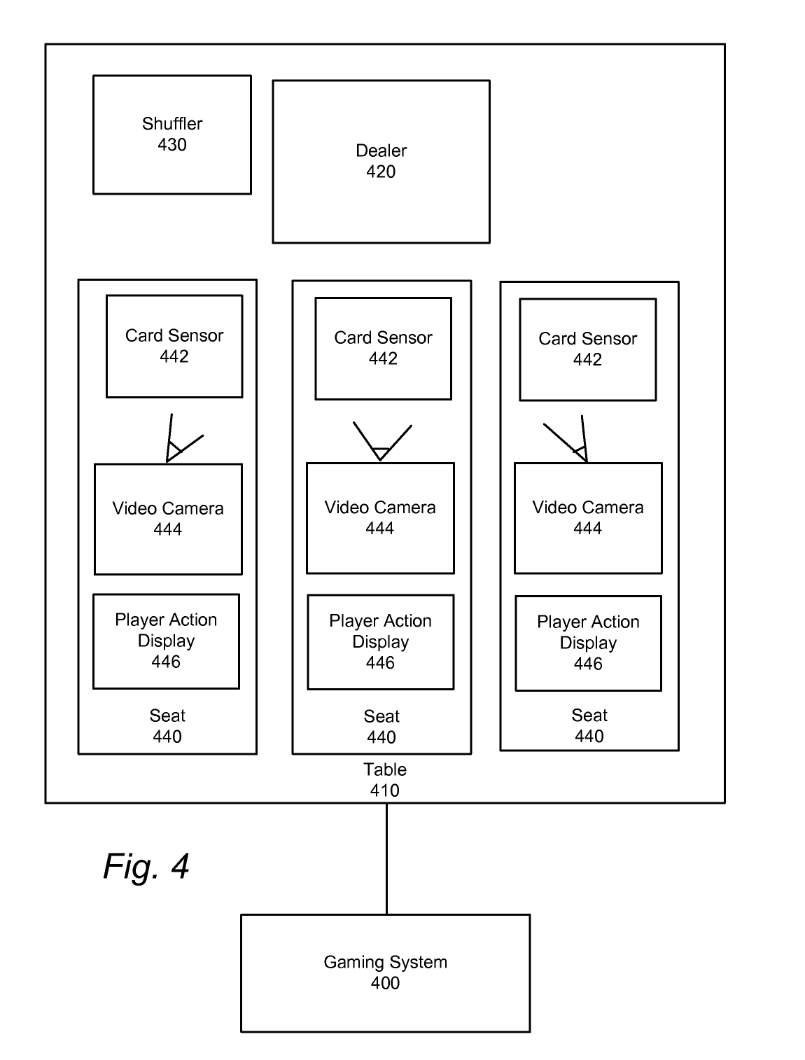

FIG. 4 is a block diagram of a gaming system providing for live dealer play for a user at a remote user device according to one embodiment. In this embodiment, the wagering games described herein are provided to a player on a user device (not shown) by a live dealer 420 at a table 410. In this embodiment, the live dealer 420 and table 410 provide the game engine functionality to the gaming system 400 by executing game mechanics and providing game action and results to the gaming system 400. The live dealer 420 receives cards from a shuffler 430 and distributes the cards to players according to the gameplay rules. When players join and leave the game, players join a seat 440 at the table 410. The table 410 includes the number of seats 440 according to the number of seats 440 allotted to the particular game being played.

In this embodiment, each seat at the table 410 includes a card sensor 442, a video camera 444, and a player action display 446. The player at a seat 440 is provided a view of the table from video camera 444. The video camera 444 provides a video feed to the user device operated by the player showing the player action on the table 410 and provides the player a view of the dealer 420 and the shuffler 430. Thus, the player receives a live view of activities at the table 410 while the user plays the game.

The card sensor 442 includes positions for the dealer 420 to place cards as the cards are dealt to the dealer. The card sensor 442 may be in view of the video camera 444, or the card sensor 442 may not be in view of the video camera 444. When the card sensor 442 is in view of the video camera 444, the dealer 420 may deal the cards to the positions face-up so the video camera 444 may view the cards dealt to the player. When the card sensor 442 is not viewable by the player, the card sensor 442 may be placed underneath the camera and provide the illusion that the dealer 420 is providing cards to the player, as the cards are dealt underneath the video camera 444 and leave the video camera's 444 view. The cards dealt to the player are transmitted to the gaming system 400 and subsequently the user device and displayed to the player. The particular cards dealt to the player may be determined in various ways. In one embodiment, the shuffler 430 includes a card reader that identifies particular rank and suit (and any other relevant characteristics) of a card as the card leaves the shuffler. The shuffler may also know the seat that the card will be dealt to. As such, the shuffler 430 may provide the card information to the gaming system 400. When the card is dealt to the seat 440, the card sensor 442 detects the presence of the card (e.g. by blocking light to a sensor at the card position). The card sensor 442 indicates the presence of the card to the shuffler 430 and the shuffler 430 indicates the card provided to the seat 440 to the gaming system 400.

Alternatively, the card sensor 442 may detect the rank and suit of the card. The card sensor 442 identifies the cards by a variety of means. In one embodiment, the card sensor 442 comprises a translucent panel placed over a scanner. When a card is played over the card sensor 442, the scanner reads the card through the translucent panel and provides the card information to the gaming system 400. In another embodiment, the card sensor 442 includes a radio-frequency identification (RFID) reader (or interrogator). In this embodiment, each card includes a RFID tag responsive to the RFID reader, the tag indicating the card's rank and suit when interrogated by the RFID reader. When the dealer places the card on the position of the card for the seat 440, the RFID reader interrogates the RFID tag in the card and obtains the card's characteristics. The card's characteristics are provided to the gaming system 400 for communication with the user device of the player at the seat 440. Other card identification methods may be used by the card sensor 442 to identify the card placed at seat 440.

The seat 440 also includes a player action display 446. As players place wagers, and execute game actions on the respective user devices, the players' activities are transmitted to the player action display 446. The player action display 446 is a visual display for the dealer 420 of the player's action. For example, the action display may indicate when a user has placed a bet, folded, or interacted with the game according to actions permitted by the game rules. In one embodiment, the player action display 446 also provides a video feed to the dealer 420 of a camera at the user device. The camera may be used to show, for example, the user as the user plays the game, thus enabling a face-to-face view of the player to the dealer though the player is not at the table 410. In one embodiment, the player action display 446 shows the amount of time since a user has taken an action. The amount of time the user has taken an action is used by the dealer to determine whether to wait for the player or whether to continue with play when the player has been idle. The player actions may also be shown to each user device to indicate the actions taken by other players during the game.

The shuffler 430 is an automatic card shuffler that shuffles cards for the game being played. The shuffler 430 includes, in one embodiment, a card reader that indicates individual cards or groups of cards as the cards are dealt by the shuffler 430. The shuffler 430 may also be programmed for the rules of the game being dealt and may be able to determine, for example, the particular cards to be dealt to individual players. The shuffler 430 provides the card information to the gaming system 400. Thus, the gaming system 400 using the table 410 allows a user to be remotely located at a user device while maintaining a live casino feel by viewing action at the table 410. Since actual cards are shuffled by shuffler 430 and a dealer 420 deals the cards, the user is able to enjoy a live game playing format. The dealt cards are provided to the user device operated by the user and the user's actions are provided to the table 410 by the player action display 446. The dealer 420 uses the player action display 446 to determine what actions to take to complete the game. Because the player has a view of the dealer 420, the dealer 420 can also interact directly with players and respond to particular players. For example, the dealer may gesture to a particular player that it is that player's turn to perform an action in the game. In addition, the user may communicate with the dealer 420, either by speaking to the dealer using a microphone, or the player may provide a message to the dealer through the player action display 446. For example, a player who does not know how to play the game may type a query into the user device, and query may appear in the player action display 446, and the dealer 420 may explain the game rules to the video camera 444 of the seat 440 for the player requesting the information. Thus, players can play the wagering games of this description in an environment simulating live play.

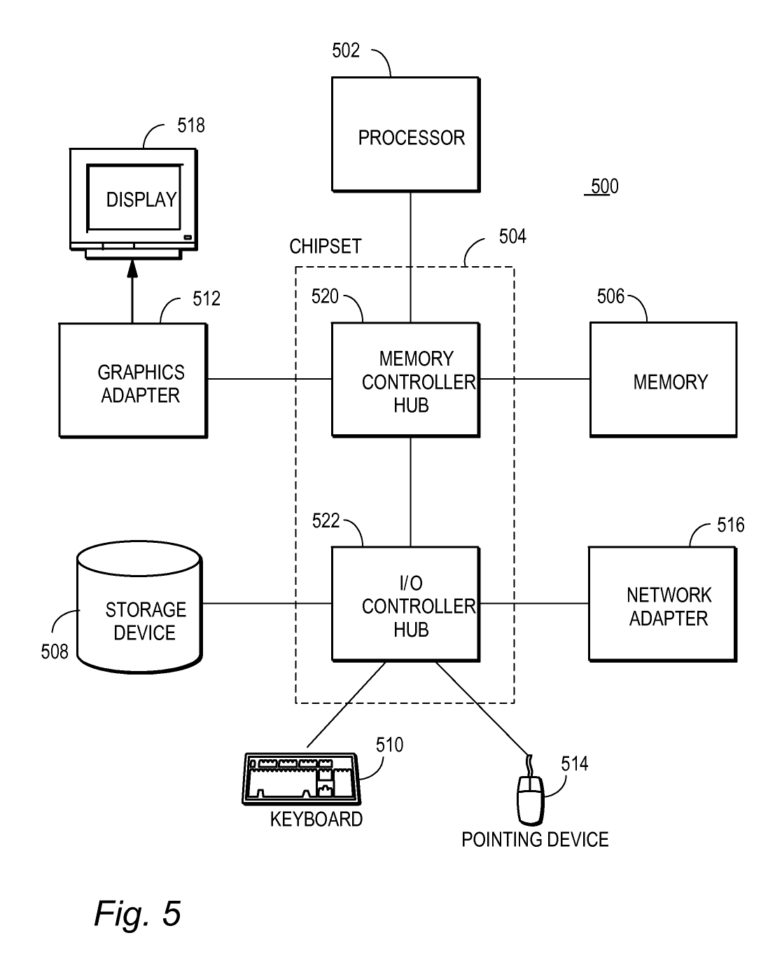

FIG. 5 is a high-level block diagram of a computer 500 for acting as a gaming system 200, 300, or 400 according to one embodiment. Illustrated are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is any non-transitory computer-readable storage medium, such as a hard drive, compact disk read-only memory (CD-ROM), DVD, or a solid-state memory device. The memory 506 holds instructions and data used by the processor 502. The pointing device 514 may be a mouse, track ball, or other type of pointing device, and is used in combination with the keyboard 510 to input data into the computer system 500. The graphics adapter 512 displays images and other information on the display 518. The network adapter 516 couples the computer system 500 to a local or wide area network.

A computer 500 can have different and/or other components than those shown in FIG. 5. In addition, the computer 500 can lack certain illustrated components. In one embodiment, a computer 500 acting as a gaming system lacks a keyboard 510, pointing device 514, graphics adapter 512, and/or display 518. Moreover, the storage device 508 can be local and/or remote from the computer 500 (such as embodied within a storage area network (SAN)).

A gaming system may comprise several such computers 500. The gaming system may include load balancers, firewalls, and various other components for assisting the gaming system to provide services to a variety of user devices.

The computer 500 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 508, loaded into the memory 506, and executed by the processor 502.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed:

1. A computer-implemented method of playing a four-card wagering game, the game comprising the steps of:
receiving, by a processor from a user device, an ante wager associable with a player;
dealing, by the processor, at least six cards to form a dealer's hand;
dealing, by the processor, at least five cards to form a player hand, wherein the player hand has fewer cards than the dealer's hand;
providing the player hand to the user device;
after providing the player hand to the user device, receiving a variable play wager associable with the player or a fold associable with the player, wherein the variable play wager is at least the size of the ante wager and the fold indicates a forfeit of the ante wager;
determining a best poker rank of the dealer's hand, wherein the best poker rank of the dealer's hand is the highest possible rank achieved using four cards from at least six cards forming the dealer's hand;
determining the best poker rank of the player's hand, wherein the best poker rank of the player's hand is the highest possible rank achieved using four cards from the at least five cards forming the player's hand; and
determining whether the best poker rank of the player's hand is higher, lower, or a tie with the best poker rank of the dealer's hand;
paying the ante and play wager when the best poker rank of the player's hand is higher, retaining the ante and play wager when the best poker rank of the player's hand is lower, and allocating the ante and play wager according to predetermined tie rules when the best poker rank of the player's hand is a tie.

2. The method of claim 1, wherein one of the cards in the dealer hand is revealed to the player by providing the card to the user device for display.

3. The method of claim 1, wherein the dealer is dealt at least one additional card when the best poker rank of the dealer's hand is less than a minimum predetermined poker rank.

4. The method of claim 1, wherein a variable play wager of greater then 1× the Ante wager can only be placed when the best poker rank of the player's hand exceeds a predetermined minimum poker rank.

5. The method of claim 1, wherein the variable play wager is an amount equal to an integer number multiple of the Ante wager.

6. The method of claim 5, wherein the variable play wager may be a multiple of the Ante wager selected from the group consisting of 1×, 2×, and 3×.

7. The method of claim 6, wherein a multiple greater than 1× is permitted if the best poker rank of the player's hand is greater than a predetermined poker rank.

8. A computer-implemented method of playing a four-card wagering game, the game comprising the steps of:
receiving, by a processor from a user device, an ante wager associable with a player;
receiving, by the processor from a card sensor, at least six cards to form a dealer's hand;
receiving, by the processor from the card sensor, at least five cards to form a player hand, wherein the player hand has fewer cards than the dealer's hand;
providing the player hand to the user device;
after providing the player hand to the user device, receiving a variable play wager associable with the player or a fold associable with the player, wherein the variable play wager is at least the size of the ante wager and the fold indicates a forfeit of the ante wager;
determining a best poker rank of the dealer's hand, wherein the best poker rank of the dealer's hand is the highest possible rank achieved using four cards from at least six cards forming the dealer's hand;
determining the best poker rank of the player's hand, wherein the best poker rank of the player's hand is the highest possible rank achieved using four cards from the at least five cards forming the player's hand; and
determining whether the best poker rank of the player's hand is higher, lower, or a tie with the best poker rank of the dealer's hand;
paying the ante and play wager when the best poker rank of the player's hand is higher, retaining the ante and play wager when the best poker rank of the player's hand is lower, and allocating the ante and play wager according to predetermined tie rules when the best poker rank of the player's hand is a tie.

9. The method of claim 8, wherein one of the cards in the dealer hand is revealed to the player by providing the card to the user device for display.

10. The method of claim 8, wherein the dealer is dealt at least one additional card when the best poker rank of the dealer's hand is less than a minimum predetermined poker rank.

11. The method of claim 8, wherein a variable play wager of greater then 1× the Ante wager can only be placed when the best poker rank of the player's hand exceeds a predetermined minimum poker rank.

12. The method of claim 8, wherein the variable play wager is an amount equal to an integer number multiple of the Ante wager.

13. The method of claim 12, wherein the variable play wager may be a multiple of the Ante wager selected from the group consisting of 1×, 2×, and 3×.

14. The method of claim 13, wherein a multiple greater than 1× is permitted if the best poker rank of the player's hand is greater than a predetermined poker rank.
